(19) United States
(12) Patent Application Publication
(10) Pub. No.: US 2026/0322252 A1
(43) Pub. Date: Oct. 15, 2026

(54) EFFICIENCY OPTIMIZATION IN POWER CONVERTERS

(71) Applicant: Empower Semiconductor, Inc., Milpitas, CA (US)

(72) Inventor: Trey ROESSIG, San Jose, CA (US)

(73) Assignee: Empower Semiconductor, Inc., Milpitas, CA (US)

(21) Appl. No.: 19/561,234

(22) Filed: Mar. 9, 2026

Related U.S. Application Data
(60) Provisional application No. 63/787,621, filed on Apr. 11, 2025.

(51) Int. Cl. H02M 1/32; H02M 1/08; H02M 1/38; H02M 3/158

(52) U.S. Cl. CPC H02M 1/327; H02M 1/08; H02M 1/385; H02M 3/158

(57) ABSTRACT

A circuit is disclosed. The circuit may include a half-bridge circuit having a first semiconductor switch and a second semiconductor switch coupled at a switch node. The circuit may include a temperature sensor arranged to sense a temperature of at least one of the first semiconductor switch or the second semiconductor switch. The circuit may include a control circuit arranged to adjust control parameters of at least one of the first semiconductor switch or the second semiconductor switch in response to the sensed temperature to optimize an efficiency of the half-bridge circuit within a safe operating area of the first and second semiconductor switches. The control parameters may include gate drive voltages, gate drive currents, and deadtime. The control circuit may dynamically adjust operating frequency based on temperature to maintain thermal performance while optimizing power conversion efficiency. Methods of temperature-based optimization of power converter systems are also disclosed.

### CROSS REFERENCE TO RELATED APPLICATIONS

This application claims priority to U.S. provisional patent application No. 63/787,621, for “EFFICIENCY OPTIMIZATION IN DC-DC CONVERTERS ” filed on Apr. 11, 2025, which is hereby incorporated by reference in entirety for all purposes.

### FIELD

The described embodiments relate generally to power converters, and more particularly, the present embodiments relate to efficiency optimization in power converters.

### BACKGROUND

A wide variety of electronic devices are available for consumers today. Many of these devices have integrated circuits that are powered by regulated low voltage DC power sources.

These low voltage power sources are often generated by dedicated power converter circuits that use a higher voltage input from a battery or another power source. In some applications, the dedicated power converter circuit can be one of the largest power dissipating components of the electronic device and can sometimes consume more space than the integrated circuit that it powers. As electronic devices become more sophisticated and more compact, more efficient power converter circuits are called for.

### SUMMARY

In some embodiments, a circuit is disclosed. The circuit may include a half-bridge circuit having a first semiconductor switch and a second semiconductor switch coupled at a switch node. The circuit may include a temperature sensor arranged to sense a temperature of at least one of the first semiconductor switch or the second semiconductor switch. The circuit may include a control circuit arranged to adjust control parameters of at least one of the first semiconductor switch or the second semiconductor switch in response to the sensed temperature to optimize an efficiency of the half-bridge circuit within a safe operating area of the first and second semiconductor switches.

In some embodiments, the control parameters may include at least gate drive voltages of the first and second semiconductor switches, gate drive currents of the first and second semiconductor switches, and deadtime. The deadtime may be an interval between an off time of the first semiconductor switch and an on time of the second semiconductor switch. The control circuit may be arranged to reduce the deadtime until at least one of the first temperature or the second temperature exceeds a predetermined threshold temperature.

In some embodiments, a power converter system may include a half-bridge circuit having a high-side semiconductor switch and a low-side semiconductor switch coupled at a switch node. The system may include a temperature monitoring circuit configured to measure an operating temperature of at least one of the high-side semiconductor switch and the low-side semiconductor switch. The system may include a dead-time control circuit configured to determine a dead-time interval between switching transitions and dynamically adjust the dead-time interval based on the measured operating temperature to optimize power conversion efficiency while maintaining the operating temperature below a thermal limit.

In some embodiments, methods may provide thermal management in switching power circuits by monitoring junction temperatures during switching operations. The methods may include determining optimal dead-time durations that minimize switching losses while preventing thermal runaway. The methods may include adjusting switching timing parameters based on monitored junction temperatures to maintain temperatures within safe operating ranges. The methods may include modulating switching frequencies when junction temperatures approach thermal thresholds to reduce power dissipation.

In some embodiments, methods of operating frequency optimization may include monitoring temperatures of power semiconductor switches during switching operations. The methods may include determining current operating frequencies and comparing monitored temperatures to predetermined temperature thresholds. The methods may include dynamically adjusting operating frequencies based on temperature comparisons to maintain thermal performance while optimizing power conversion efficiency. Operating frequencies may be reduced when monitored temperatures exceed predetermined temperature thresholds.

### BRIEF DESCRIPTION OF THE DRAWINGS

FIG. 1 illustrates a DC-DC converter circuit having an efficiency optimization circuit, according to some embodiments;

FIG. 2 illustrates operational timing graphs of the switches of FIG. 1 illustrating non-overlap time (deadtime);

FIG. 3 illustrates a graph of temperature as a function of deadtime of FIG. 2;

FIG. 4 is a simplified flowchart illustrating a method of optimizing deadtime of a converter according to some embodiments of the disclosure.

FIG. 5 is a simplified flowchart illustrating a method of efficiency optimization for a converter by adjusting multi-parameters, according to some embodiments of the disclosure;

FIG. 6 is a simplified flowchart illustrating a method of efficiency optimization for a converter, according to some embodiments of the disclosure; and

FIG. 7 shows simplified schematic of a semiconductor die having a temperature sensor, according to some embodiments.

### DETAILED DESCRIPTION

Circuits, devices and related techniques disclosed herein relate generally to power converters. More specifically, circuits, devices and related techniques disclosed herein relate to efficiency optimization in power converters. In some embodiments, in a DC-DC power converter having a first switch and a second switch, a temperature of the first switch or the second switch can be detected and a control circuit can be arranged to control a delay time between an off time of the first switch and an on time of the second semiconductor switch. The control circuit can reduce the delay time until the detected temperature exceeds a predetermined threshold temperature. The control circuit may increase the delay time by a predetermined safety margin. In this way, the converter may operate with maximum efficiency while keeping the switch in its safe operating area (SOA). In various embodiments, the control circuit can be arranged to optimize the gate drive voltage based on the detected temperature. In some embodiments, the control circuit can be arranged to optimize the gate drive current based on the detected temperature. In various embodiments, the control circuit can be arranged to optimize the operating frequency of the converter based on the detected temperature.

In some embodiments, the control circuit can be all-digital using a digital temperature sensor and microcontroller to implement disclosed methods. In various embodiments, the control circuit can include a comparator circuit and up/down counter circuits, and can be arranged to use sampled analog temperature information. In some embodiments, the control circuit can be arranged to run an efficiency optimization method to optimize the delay time between the off time of the first switch and the on time of the second semiconductor switch, gate drive strength, and/or operating frequency based on the detected temperature. The control circuit can be arranged to run Monte Carlo analysis, system identification analysis, or can perform the optimization method using artificial intelligence. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

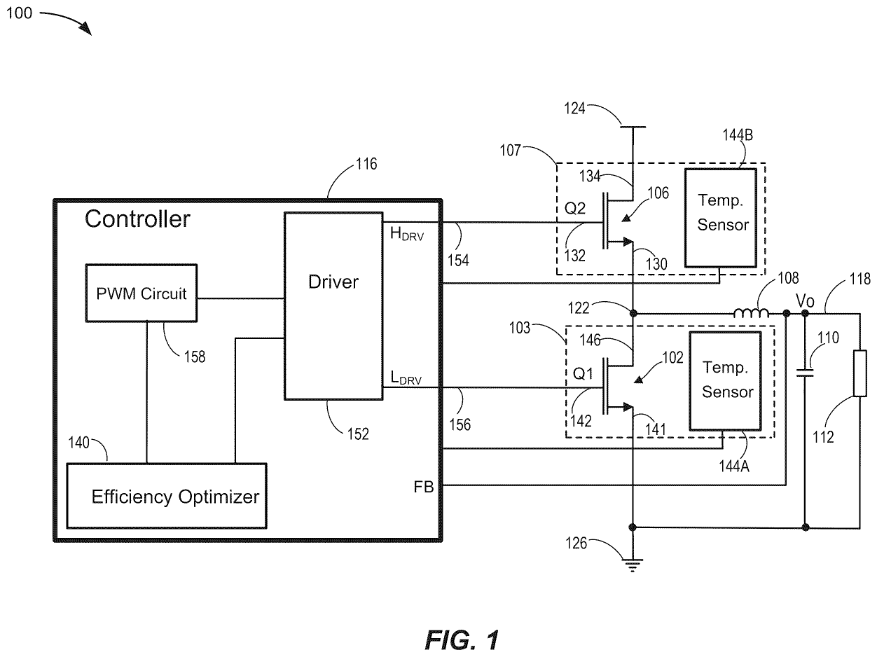

FIG. 1 illustrates a DC-DC converter circuit having an efficiency optimization control circuit, according to some embodiments. In the illustrated embodiment, circuit 100 can include a switch 102 coupled to a switch 106 at a switch node 122, an inductor 108 coupled to the switch node, and a controller circuit 116 coupled to switches 102 and 106. The switch 102 can include a gate terminal 142, a source terminal 141 and a drain terminal 146. The switch 106 can include a gate terminal 132, a source terminal 130 and a drain terminal 134. The inductor 108 can be coupled to an output capacitor 110 and to a load 112 at an output terminal 118. The switch 106 can be coupled to an input voltage at input terminal 124 and the switch 102 can be coupled to a ground 126. Temperature sensing circuits 144A and 144B may be integrated with the switches 102 and 106, respectively, on their respective die 103 and 107, and can be arranged to detect a temperature of the switches 102 and 106 and transmit the detected temperatures to the controller circuit 116. In some embodiments, the temperature sensing circuits 144A and 144B can be a resistance temperature detector (RTD) integrated within the switch 102 and/or switch 106. In some embodiments, a temperature sensing circuit can be integrated on the controller circuit 116.

In some embodiments, the switches 102 and 106 may be transistors. In various embodiments, the transistors may be silicon-based field effect transistors (FET). In some embodiments, the transistors may be metal-oxide-semiconductor field effect transistors (MOSFETS). In various embodiments, the switches can be gallium nitride (GaN)-based, silicon carbide-based and/or diamond based.

Circuit 100 can be arranged to receive an input voltage at input terminal 124 and generate an output voltage Vo at the output terminal 118. The controller circuit 116 may be arranged to control conductivity states of the switches 102 and 106. The controller circuit 116 may further be arranged to receive a feedback signal from the output terminal 118. The controller circuit 116 can include a driver circuit 152 and a pulse-width modulated (PWM) signal generation circuit 158. The driver circuit 152 can include a high-side drive output terminal 154 coupled to the gate terminal 132 and a low-side drive output terminal 156 coupled to the gate terminal 142. In some embodiments, the controller circuit 116 can include an efficiency optimizer circuit 140. The efficiency optimizer circuit 140 can be arranged to receive switch detected temperatures from switches 102 and 106. Based on the received sensed temperature, the efficiency optimization circuit 140 can control and optimize a delay time between an off time of the first switch and an on time of the second semiconductor switch. The delay time between the off time of the first switch and the on time of the second semiconductor switch can also be referred to as deadtime. In some embodiments, efficiency optimization may not imply operating the power conversion circuit as hard as possible, rather it may imply operating the power conversion circuit with a margin of safety. In various embodiments, efficiency optimization may imply operating within the safe operating area (SOA) having a safety margin of, for example, 5 or 10%. The SOA of a switch can be determined, for example, from the tested characteristics of the switch. Efficiency optimization can take into account performance, operating voltage and/or operating currents.

In some embodiments, the efficiency optimization circuit 140 can be arranged to optimize a gate drive strength (voltage and/or current) into the gate terminals of the switch 102 and 106 based on the detected temperature information. The gate drive strength optimization may include gate drive current optimization and/or gate drive voltage optimization. In various embodiments, the efficiency optimization circuit 140 can be arranged to optimize switching frequency of the switches 102 and 106 based on the detected temperature information. In some embodiments, circuits and techniques disclosed herein can be used in a full-bridge circuit. In some embodiments, the efficiency can be determined dividing the output power by the input power. It can be calculated by measuring voltage and current at the input and output. In some embodiments, the control circuit 116 can be arranged to adjust control parameters, including deadtime, gate drive voltage and/or gate drive current. In certain embodiments, an on time of the semiconductor switch can be adjusted in response to the sensed temperature of the semiconductor switch.

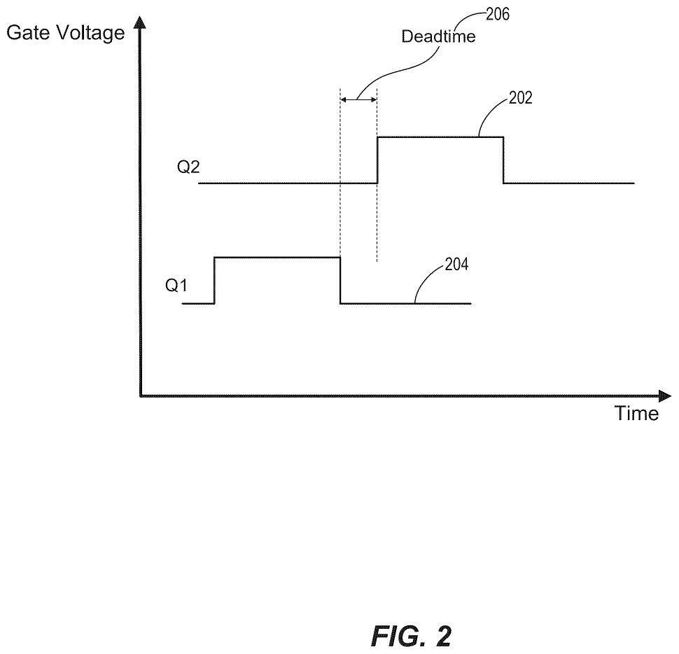

FIG. 2 illustrates operational timing graphs of switches 102 and 106 of FIG. 1, illustrating deadtime. In FIG. 2, gate voltages of switch 102 (labeled Q1) 204 and gate voltages of switch 106 (labeled Q2) 202 are shown during operation. In circuit 100, a deadtime 206 interval can prevent shoot-through from occurring. During shoot-through both switches 102 and 106 are on at the same time. During a shoot-through event, current may flow directly from the input terminal 124 to ground 126, creating a short between power supply and ground. A shoot-through event may cause the temperature of the switches 102 and 106 to increase rapidly and exceed their safe operating areas (SOA). Therefore, circuit 100 may operate with a deadtime such as to prevent shoot-through. A semiconductor switch's safe operating area (SOA) defines the voltage (Vds) and current (Id) limits where the switch operates reliably without damage, key for preventing thermal runaway and ensuring reliable operation of the switch.

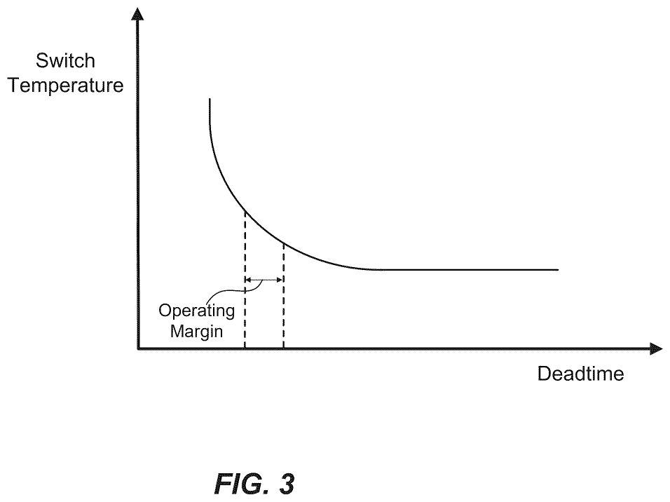

FIG. 3 illustrates a graph of switch temperature as a function of deadtime. As deadtime is increased, temperature may decrease as the switches operate away from shoot-through region of operation. However, increased deadtime causes a reduction of converter efficiency. Thus, it is beneficial to operate at a minimum deadtime without increasing temperature of the switches. In some embodiments, the controller circuit 116 can be arranged to reduce deadtime based on detected temperature and compare the detected temperature to a predetermined temperature.

When the detected temperature exceeds the predetermined temperature, the control circuit can stop reducing the deadtime and add a safety margin to the deadtime to generate a new deadtime for the operation of the converter. In this way, the converter may operate with maximum efficiency while keeping the switches in their safe operating area (SOA). The control circuit 116 can continuously receive the detected temperature and compare it to the predetermined temperature threshold and adjust the value of the deadtime accordingly.

In some embodiments, a control circuit used in a DC-DC converter can be all-digital using a digital temperature sensor and microcontroller to implement disclosed methods. In various embodiments, the control circuit can include a comparator circuit and up/down counter circuits and can be arranged to use sampled analog temperature information. In some embodiments, the control circuit can be arranged to run an efficiency optimization method to optimize deadtime, gate drive strength and operating frequency based on the detected temperature. The control circuit can be arranged to run Monte Carlo analysis, system identification analysis, and/or can perform the optimization methods using artificial intelligence.

In some embodiments, a temperature sensor can be integrated into the same die as the power switch die. In certain embodiments, the temperature sensor can be disposed in the same semiconductor package as the semiconductor switch. In various embodiments, a temperature sensor may include a resistance temperature detector (RTD) sensor, where its resistance can change as temperature changes. In some embodiments, a temperature sensor may include diode-based temperature sensor. In various embodiments, a temperature sensor may include a thermistor-based temperature sensor. In some embodiments, temperature sensor may include an external temperature sensor such as, but not limited to, a thermocouple attached to the power switch. In various embodiments, the thermocouple may be glued to the power switch. In some embodiments, temperature sensor may be integrated into the control circuit. Embodiments of the disclosure can use these as well as other temperature sensors and are within the scope of this disclosure. Temperature sensor may also be referred to as a temperature sensing circuit.

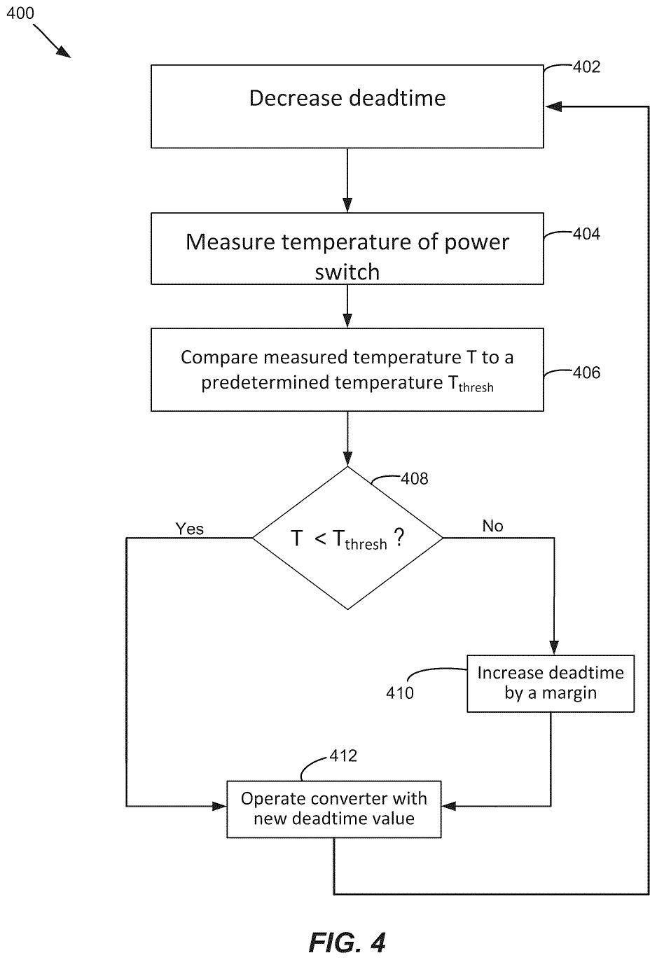

FIG. 4 is a simplified flowchart illustrating a method 400 of optimizing deadtime of a converter according to some embodiments of the disclosure. As illustrated in FIG. 4, the method of optimizing deadtime includes decreasing deadtime of the converter (402). The method also includes measuring a temperature of a power switch (404). In some embodiments, temperatures of both power switches may be measured. In various embodiments, temperature of all power switches, for example in a full-bridge, can be measured and transmitted to the control circuit. In some embodiments, a temperature of the control circuit may be measured. The method also includes comparing measured temperature T to a predetermined temperature Tₜₕᵣₑₛₕ (406). The method further includes determining if the measured temperature T is less than the predetermined temperature Tₜₕᵣₑₛₕ (408). Additionally, the method includes increasing the deadtime by a safety margin to generate DT_{margin} if the measured temperature T is less than the predetermined temperature Tₜₕᵣₑₛₕ (410). The control circuit can operate the converter using DT_{margin} (412). If the measured temperature T is greater than or equal the predetermined temperature Tₜₕᵣₑₛₕ, the control circuit can operate the converter with the new deadtime value.

The control circuit can loop back to 402 and continue to execute this method.

It should be appreciated that the specific steps illustrated in FIG. 4 provide a particular method of optimizing deadtime of a converter according to an embodiment of the disclosure. Other sequences of steps may also be performed according to alternative embodiments. For example, alternative embodiments of the disclosure may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. One of ordinary skill in the art would recognize many variations, modifications, and alternatives.

In some embodiments, a control circuit in a DC-DC converter can be arranged to optimize the gate drive voltage of the first and second switches based on the detected temperature. For example, when the measured temperature exceeds a predetermined temperature value, the control circuit may increase the gate drive voltage beyond the safe rated gate terminal voltage of the power switches for a relatively brief time period, for example, for 50-100 nS. In this way, the converter can operate efficiently, and the switch can continue to operate reliably while temperature of the switch is reduced. In some embodiments, when the detected temperature exceeds a predetermined value the control circuit may shut down the operation of the converter in order to prevent damage to the switches. In various embodiments, when the detected temperature exceeds a predetermined threshold, the control circuit may reduce gate drive strength.

In various embodiments, a control circuit in a DC-DC converter can be arranged to optimize the gate drive current of the first and second switches based on the detected temperature. For example, when the measured temperature exceeds a predetermined temperature value, the control circuit may increase the gate current charging and/or discharging the gate capacitance of the switches. In this way, the converter can operate efficiently, and the switches can continue to operate reliably while temperature of the switch is reduced.

In some embodiments, the control circuit can be arranged to optimize the operating frequency of the DC-DC converter based on the detected temperature. When the detected temperature exceeds a predetermined temperature value, the control circuit can be arranged to reduce the operating frequency until the measured temperature is reduced to less than the predetermined temperature value. In various embodiments, the control circuit can be arranged to stop the operation of the converter for a relatively small time period, for example for a 1-2 mS, measure the temperature of power switches and determine if the detected temperature is less than a predetermined threshold temperature. The control circuit can resume operation of the converter at a frequency such that the next measured temperature stays less than the predetermined threshold temperature. In this way, power switches can be kept within their safe operating area. The predetermined threshold temperature can be a temperature or a set of temperature residing in a look-up table inside the control circuit 116. The predetermined threshold temperature may be derived from the tested characteristics of the switch such that the switch may operate in its SOA. In some embodiments, the predetermined threshold temperature can be programmed by a user. In various embodiments, the predetermined threshold temperature can be transmitted to the control circuit via a wireless network.

In some embodiments, the control circuit can be arranged to run an efficiency optimization method to optimize deadtime, gate drive strength and operating frequency based on the detected temperature. The control circuit can be arranged to execute methods described in FIG. 4 to optimize deadtime, where the control circuit can adjust the gate drive voltage, gate drive current and operating frequency as described above. The control circuit can be arranged to continuously execute this multi-parameter efficiency optimization using Monte Carlo analysis, system identification analysis, or can perform multi-parameter optimization using artificial intelligence. In some embodiments of multi-parameter efficiency optimization, the deadtime may be given a higher priority while the gate drive voltage may be given a second priority and the gate drive current may be given a third priority.

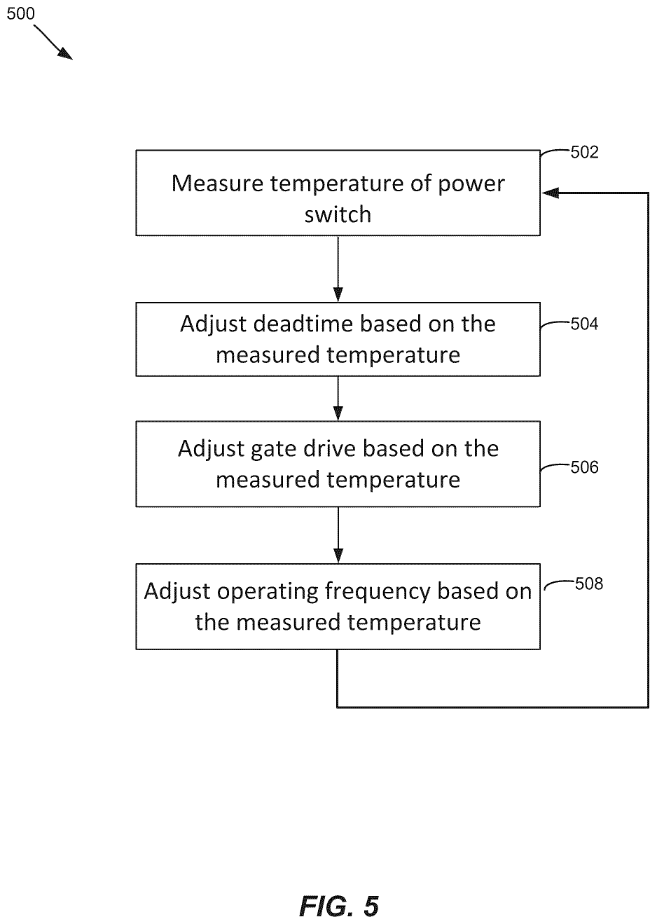

FIG. 5 is a simplified flowchart illustrating a method 500 of efficiency optimization for a converter by adjusting multi-parameters, according to some embodiments of the disclosure. As illustrated in FIG. 5, the method of efficiency optimization includes measuring the temperature of the power switch (502). In some embodiments, the temperature measurement may include measuring a temperature of the control circuit. The method also includes adjusting deadtime based on the measured temperature (504). In some embodiments, temperatures of both power switches may be measured. In various embodiments, temperature of all power switches, for example in a full-bridge, can be measured and transmitted to the control circuit. The method also includes adjusting gate drive strength, gate voltage and/or gate current drive, based on the measured temperature (506). The method further includes adjusting operating frequency of the converter based on the measured temperature (508). For example, the operating frequency may be reduced if the measured temperature exceeds a predetermined temperature value. The methods can loop back to 502 and measure the temperature and continue to adjust multi-parameters to optimize efficiency of the converter.

It should be appreciated that the specific steps illustrated in FIG. 5 provide a particular method of optimizing efficiency of a converter according to an embodiment of the disclosure. Other sequences of steps may also be performed according to alternative embodiments. For example, alternative embodiments of the disclosure may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

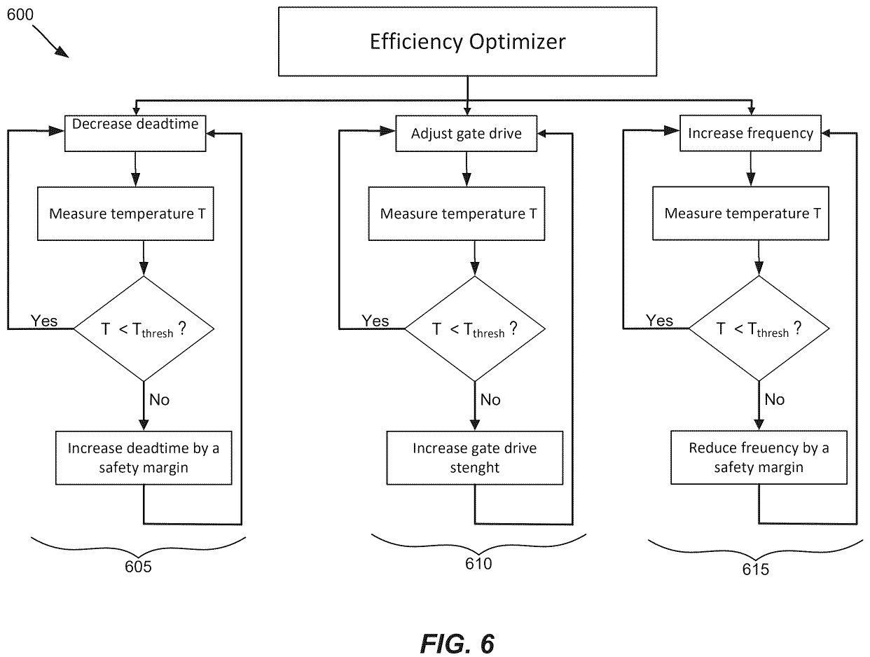

FIG. 6 is a simplified flowchart illustrating a method 600 of efficiency optimization for a converter, according to some embodiments of the disclosure. As illustrated in FIG. 6, the method of efficiency optimization includes measuring the temperature and adjusting the deadtime (605), adjusting the gate drive strength (610), and/or adjusting the operational frequency (615) based on the measured temperature. It should be appreciated that the specific steps illustrated in FIG. 6 provide a particular method of optimizing efficiency of a converter according to an embodiment of the disclosure. Other sequences of steps may also be performed according to alternative embodiments. For example, alternative embodiments of the disclosure may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

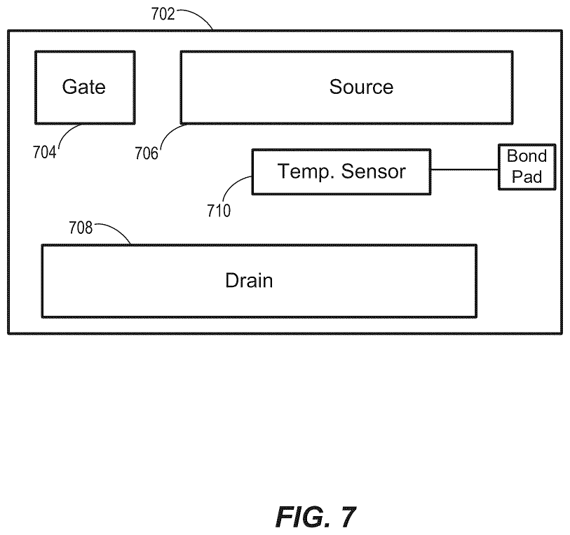

FIG. 7 shows a semiconductor die having a temperature sensor, according to some embodiments. FIG. 7 shows a semiconductor die 702 that can include a switch having a gate terminal 704, a source terminal 706 and a drain terminal 708. The semiconductor die 702 can include a temperature sensing circuit 710. The temperature sensing circuit 710 can be coupled to a bonding pad such that the sensed temperature of the die can be transmitted to a controller. In some embodiments, the temperature sensing circuit 710 can be coupled to multiple bonding pads.

In some embodiments, combination of the circuits and methods disclosed herein can be utilized to provide efficiency optimization in DC-DC converters. Although circuits and methods are described and illustrated herein with respect to several particular configurations of DC-DC buck converter circuits, embodiments of the disclosure are suitable for efficiency optimization in other power converter circuits, such as, but not limited to, boost and buck-boost circuits. In various embodiments, circuits and techniques disclosed herein can be used for a boost converter. In some embodiments, circuits and techniques disclosed herein can be used for a buck-boost converter. In various embodiments, circuits and techniques disclosed herein can be used in a full-bridge circuit. In some embodiments, circuits and techniques disclosed herein can be used in a power converter having a first semiconductor switch, a temperature sensor arranged to sense a temperature of the first semiconductor switch, and a control circuit arranged to adjust at least one of an on time, a gate drive voltage, or a gate drive current of the first semiconductor switch in response to the sensed temperature to optimize an efficiency of the power conversion circuit within a safe operating area of the first semiconductor switch.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “and/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A circuit comprising:
a half-bridge circuit including a first semiconductor switch connected to a second semiconductor switch at a switch node;
a temperature sensor arranged to sense at least one of a first temperature of the first semiconductor switch or a second temperature of the second semiconductor switch; and
a control circuit arranged to adjust control parameters of at least one of the first semiconductor switch or the second semiconductor switch in response to the sensed temperature to optimize an efficiency of the half-bridge circuit within a safe operating area of the first and second semiconductor switches.

2. The circuit of claim 1, wherein the control parameters include at least gate drive voltages of the first and second semiconductor switches, gate drive currents of the first and second semiconductor switches, and deadtime, wherein the deadtime is an interval between an off time of the first semiconductor switch and an on time of the second semiconductor switch.

3. The circuit of claim 2, wherein the control circuit is further arranged to reduce the deadtime until at least one of the first temperature or the second temperature exceeds a predetermined threshold temperature.

4. The circuit of claim 3, wherein the control circuit is further arranged to increase the deadtime by a predetermined margin when at least one of the first temperature or the second temperature exceeds the predetermined threshold temperature.

5. The circuit of claim 1, wherein the first semiconductor switch comprises a first source terminal, a first gate terminal and a first drain terminal, wherein the first drain terminal is connected to an input terminal.

6. The circuit of claim 5, wherein the second semiconductor switch comprises a second source terminal, a second gate terminal and a second drain terminal, the first drain terminal coupled to the second source terminal at the switch node, and the first source terminal coupled to a ground.

7. The circuit of claim 1, wherein the temperature sensor is disposed in a semiconductor package housing at least one of the first semiconductor switch or the second semiconductor switch.

8. A power conversion circuit comprising:
a first semiconductor switch;
a temperature sensor arranged to sense a temperature of the first semiconductor switch; and
a control circuit arranged to adjust at least one of an on time, a gate drive voltage, or a gate drive current of the first semiconductor switch in response to the sensed temperature to optimize an efficiency of the power conversion circuit within a safe operating area of the first semiconductor switch.

9. The power conversion circuit of claim 8, further comprising a second semiconductor switch connected to the first semiconductor switch at a switch node.

10. The power conversion circuit of claim 9, wherein the temperature sensor is further arranged to sense a temperature of the second semiconductor switch.

11. The power conversion circuit of claim 10, wherein the control circuit is further arranged to adjust at least one of the gate drive voltage of the second semiconductor switch, or a gate drive current of the second semiconductor switch, or a deadtime in response to the sensed temperature to optimize the efficiency of the power conversion circuit within a safe operating area of the second semiconductor switch, wherein the deadtime is an interval between an off time of the first semiconductor switch and an on time of the second semiconductor switch.

12. The power conversion circuit of claim 9, wherein the first semiconductor switch comprises a first source terminal, a first gate terminal and a first drain terminal, wherein the first drain terminal is connected to an input terminal.

13. The circuit of claim 12, wherein the second semiconductor switch comprises a second source terminal, a second gate terminal and a second drain terminal, the first drain terminal coupled to the second source terminal at the switch node, and the first source terminal coupled to a ground.

14. A method of operating frequency optimization in a power converter, the method comprising:
monitoring a temperature of at least one power semiconductor switch in the power converter during switching operations;
determining an operating frequency of the power converter;
comparing the monitored temperature to a predetermined temperature threshold; and
dynamically adjusting the operating frequency of the power converter based on the temperature comparison to maintain thermal performance while optimizing power conversion efficiency, wherein the operating frequency is reduced when the monitored temperature exceeds the predetermined temperature threshold.

15. The method of claim 14, wherein the power converter comprises a half-bridge circuit having a high-side semiconductor switch and a low-side semiconductor switch, and wherein monitoring the temperature comprises measuring temperatures of at least one of the high-side semiconductor switch or the low-side semiconductor switch.

16. The method of claim 14, wherein dynamically adjusting the operating frequency comprises reducing the operating frequency by a predetermined percentage when the monitored temperature exceeds the predetermined temperature threshold.

17. The method of claim 14, wherein the predetermined temperature threshold is selected based on a safe operating area specification of at least one power semiconductor switch.

18. The method of claim 14, further comprising increasing the operating frequency when the monitored temperature falls below a lower temperature threshold to maximize power conversion efficiency.

19. The method of claim 14, wherein the power converter operates in a switching mode, and wherein dynamically adjusting the operating frequency comprises modifying a switching period of the at least one power semiconductor switch.

20. The method of claim 14, further comprising adjusting at least one of a gate drive voltage or a gate drive current of the at least one power semiconductor switch in conjunction with adjusting the operating frequency to provide coordinated thermal and efficiency optimization.
